(19) United States
(12) Patent Application Publication
(10) Pub. No.: US 2003/0061364 A1
(43) Pub. Date: Mar. 27, 2003

(54) Method and system in electronic commerce for providing a secure wireless connection service for mobile personal area networks

(75) Inventors: Dwip N. Banerjee, Austin, TX (US); Rabindranath Dutta, Austin, TX (US); Karthikeyan Ramamoorthy, Austin, TX (US)

Correspondence Address: Joseph R. Burwell, Law Office of Joseph R. Burwell, P.O. Box 28022, Austin, TX, 78755-8022, US

(73) Assignee: INTERNATIONAL BUSINESS MACHINES CORPORATION, ARMONK, NY (US)

(21) Appl. No.: 09/964,076

(22) Filed: Sep. 26, 2001

(51) Int. Cl. G06F 15/16

(52) U.S. Cl. 709/229; 709/249

(57) ABSTRACT

A methodology is presented for a communication service that allows a user of a wireless mobile personal area network (PAN) to securely connect to a remote PAN. An operator of a wireless PAN network access provider (WPNAP) service activates a stationary PAN. In response to a determination that a wireless mobile PAN has entered a service area of the stationary PAN, the WPNAP service is offered to the wireless mobile PAN. Upon acceptance of the offer of its service, the WPNAP service allows the wireless mobile PAN to connect to a global communication network via the stationary PAN; a secure communication session may be established with a remote PAN. The communication session is monitored by the WPNAP service, and a financial transaction is then generated to charge usage fees to the user of the wireless mobile PAN for use of the WPNAP service during the monitored session.

### BACKGROUND OF THE INVENTION

1. Field of the Invention

The present invention relates to an improved data processing system and, in particular, to a method and system for automated electronic commerce. Still more particularly, the present invention provides a method and system for facilitating an electronic commerce transaction for computer network communication.

2. Description of Related Art

Technological progress can be classified and analyzed within certain categories, e.g., progress in communication networks versus progress in the miniaturization of digital devices. With respect to progress within communication networks, commercial and personal use of the Internet has increased dramatically with most electronic communication now occurring in some manner through the Internet rather than completely through private digital communication networks. With respect to progress in the miniaturization of digital devices, many different types of portable digital devices are now available, such as laptop computers, mobile phones, and personal digital assistants (PDAs).

These technological trends are interconnected such that progress within one category spurs innovation within another category. For example, the importance of Internet-based communication has increased demands from consumers that portable digital devices should have Internet-connectivity in some form. While laptop computers have been able to connect to the Internet through standard modems for many years, many different types of portable digital devices have become individually connectable to the Internet, i.e. Internet-enabled. As a result, Internet access is increasingly occurring through portable devices, and more importantly, through wireless Internet connections.

While having access to multiple Internet-enabled devices can enhance one's productivity, maintaining multiple accounts with multiple communication service providers can be burdensome. Most corporations and individuals access the Internet through an Internet service provider (ISP), but one must typically purchase wireless communication services for different Internet-enabled devices through one or more different communication service providers.

Moreover, one's productivity can be hampered by the inability to connect and/or interface a set of portable digital devices as desired. While the recent promulgation of standards, such as Bluetooth™, has reduced the effort to locally interface multiple devices by facilitating the simple creation of personal area networks (PANs) using convenient wireless means, one must still overcome barriers associated with so-called “connectivity islands”. A connectivity island is a location having one or more digital devices that are interconnected in some manner, such as a personal area network, a local area network, direct cable connections, etc., but not usefully accessible by remote devices. In other words, the devices within a given connectivity island are inaccessible from remote devices, including their owners or operators, either because the connectivity island is not constantly connected to the Internet or because remote access to the connectivity island is prevented due to security risk concerns. Hence, non-connectivity is a form of surrounding barrier that prevents remote access to the connectivity island.

For example, a home office may have multiple digital devices that comprise a personal area network, and one or more of the devices may have a connection to the Internet that allows a user of the device to access the Internet from the home office. However, when the user is away from the home office, the user is unable to access any data stored on the devices in the home office or to access any functionality that could be offered by those devices.

With the advent of wireless personal area networks, the issue of connectivity islands has become more prevalent. Using Bluetooth™ technology, a user can easily establish a wireless personal area network between a common set of mobile digital devices, such as a mobile phone, a PDA, and a headset. However, if a traveling user needs immediate access to a given dataset that is permanently stored within a personal area network in a home office, the user typically must download the dataset to the PDA, although the user could also upload the dataset to an Internet data storage service and then access the dataset through the PDA using a wireless Internet connection. In either case, the user's productivity has been increased by employing small, mobile, personal digital devices using ubiquitous Internet-based communication technology. Nonetheless, the user's productivity could be enhanced if the user had the certainty of maintaining the dataset in a single, secure, permanent, personal area network while knowing that the dataset would be accessible via the digital devices in the user's mobile, wireless, personal area network.

Therefore, it would be advantageous to have a methodology for eliminating issues related to personal connectivity islands. It would be particularly advantageous to facilitate a methodology in electronic commerce for eliminating the issues related to personal connectivity islands with respect to mobile personal area networks.

### SUMMARY OF THE INVENTION

A method, a system, an apparatus, and a computer program product are presented for providing a communication service that allows a user of a wireless mobile personal area network (PAN) in operational proximity to a stationary PAN to securely connect to a remote PAN via a communications network. An operator of the wireless PAN network access provider service activates a stationary PAN consisting of a plurality of distributed servers. In response to a determination that a wireless mobile PAN has entered a service area of the stationary PAN, e.g., when a user walks into a building in which the operator has installed the wireless PAN network access provider service, the wireless PAN network access provider service is offered to the wireless mobile PAN. Upon acceptance of the offer of its service, the wireless PAN network access provider service allows the wireless mobile PAN to connect to a global communication network via the stationary PAN. The communication session is monitored by the wireless PAN network access provider service, and a financial transaction is then generated to charge usage fees to the user of the wireless mobile PAN for use of the network access provider service during the monitored session.

### BRIEF DESCRIPTION OF THE DRAWINGS

The novel features believed characteristic of the invention are set forth in the appended claims. The invention itself, further objectives, and advantages thereof, will be best understood by reference to the following detailed description when read in conjunction with the accompanying drawings, wherein:

FIG. 1A depicts a typical distributed data processing system in which the present invention may be implemented;

FIG. 1B depicts a typical computer architecture that may be used within a data processing system in which the present invention may be implemented;

FIGS. 2A-2B depict two typical representations of a wireless personal area network;

FIG. 2C depicts a typical Bluetooth™ protocol stack;

FIG. 3A depicts a flowchart of a typical discovery and connection process for Bluetooth™-enabled devices;

FIG. 3B depicts a flowchart showing further details for establishing a link between Bluetooth™-enabled devices;

FIG. 3C depicts a flowchart of a typical process for discovering services that are supported by the responding Bluetooth™-enabled devices;

FIG. 3D depicts a flowchart of a typical process for establishing a connection to a service that is supported by a Bluetooth™-enabled device;

FIG. 4 depicts a block diagram showing some of the functional and physical components that may be interfaced to implement a secure wireless PAN network access provider (WPNAP) service in accordance with the present invention; and

FIGS. 5A-5B depict a set of flowcharts that show a process by which a Bluetooth™ network access provider (BNAP) service operator can offer a BNAP service and charge for its use in accordance with the present invention.

### DETAILED DESCRIPTION OF THE INVENTION

The present invention provides a method and system in electronic commerce for eliminating the issues related to personal connectivity islands with respect to mobile personal area networks. In general, the devices that may comprise or relate to the present invention are assumed to include networking technology. Therefore, as background, a typical organization of hardware and software components within a distributed data processing system is described prior to describing the present invention in more detail.

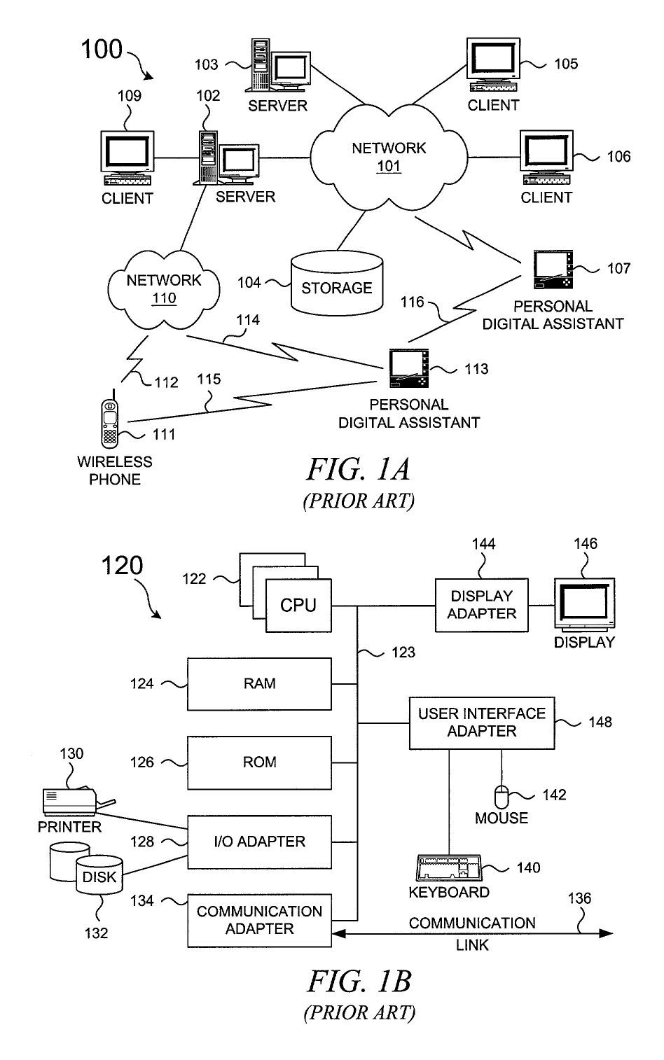

With reference now to the figures, FIG. 1A depicts a typical network of data processing systems, each of which may implement some aspect of the present invention. Distributed data processing system 100 contains network 101, which is a medium that may be used to provide communications links between various devices and computers connected together within distributed data processing system 100. Network 101 may include permanent connections, such as wire or fiber optic cables, or temporary connections made through telephone or wireless communications. In the depicted example, server 102 and server 103 are connected to network 101 along with storage unit 104. In addition, clients 105-107 also are connected to network 101. Clients 105-107 and servers 102-103 may be represented by a variety of computing devices, such as mainframes, personal computers, personal digital assistants (PDAs), etc. Distributed data processing system 100 may include additional servers, clients, routers, other devices, and peer-to-peer architectures that are not shown. It should be noted that the distributed data processing system shown in FIG. 1A is contemplated as being fully able to support a variety of peer-to-peer subnets and peer-to-peer services.

In the depicted example, distributed data processing system 100 may include the Internet with network 101 representing a global collection of networks and gateways that use various protocols to communicate with one another, such as Lightweight Directory Access Protocol (LDAP), Transport Control Protocol/Internet Protocol (TCP/IP), Hypertext Transport Protocol (HTTP), Wireless Application Protocol (WAP), etc. Of course, distributed data processing system 100 may also include a number of different types of networks, such as, for example, an intranet, a local area network (LAN), a wireless LAN, or a wide area network (WAN). For example, server 102 directly supports client 109 and network 110, which incorporates wireless communication links. Network-enabled phone 111 connects to network 110 through wireless link 112, and PDA 113 connects to network 110 through wireless link 114. Phone 111 and PDA 113 can also directly transfer data between themselves across wireless link 115 using an appropriate technology, such as Bluetooth™ wireless technology, to create so-called personal area networks (PAN) or personal ad-hoc networks. In a similar manner, PDA 113 can transfer data to PDA 107 via wireless communication link 116.

The present invention could be implemented on a variety of hardware platforms; FIG. 1A is intended as an example of a heterogeneous computing environment and not as an architectural limitation for the present invention.

With reference now to FIG. 1B, a diagram depicts a typical computer architecture of a data processing system, such as those shown in FIG. 1A, in which the present invention may be implemented. Data processing system 120 contains one or more central processing units (CPUs) 122 connected to internal system bus 123, which interconnects random access memory (RAM) 124, read-only memory 126, and input/output adapter 128, which supports various I/O devices, such as printer 130, disk units 132, or other devices not shown, such as a audio output system, etc. System bus 123 also connects communication adapter 134 that provides access to communication link 136. User interface adapter 148 connects various user devices, such as keyboard 140 and mouse 142, or other devices not shown, such as a touch screen, stylus, microphone, etc. Display adapter 144 connects system bus 123 to display device 146.

Those of ordinary skill in the art will appreciate that the hardware in FIG. 1B may vary depending on the system implementation. For example, the system may have one or more processors, such as an Intel® Pentium®-based processor and a digital signal processor (DSP), and one or more types of volatile and non-volatile memory. Other peripheral devices may be used in addition to or in place of the hardware depicted in FIG. 1B. In other words, one of ordinary skill in the art would not expect to find similar components or architectures within a Web-enabled or network-enabled phone and a fully featured desktop workstation. The depicted examples are not meant to imply architectural limitations with respect to the present invention.

In addition to being able to be implemented on a variety of hardware platforms, the present invention may be implemented in a variety of software environments. A typical operating system may be used to control program execution within each data processing system. For example, one device may run a Linux® operating system, while another device contains a simple Java® runtime environment. A representative computer platform may include a browser, which is a well known software application for accessing hypertext documents in a variety of formats, such as graphic files, word processing files, Extensible Markup Language (XML), Hypertext Markup Language (HTML), Handheld Device Markup Language (HDML), Wireless Markup Language (WML), and various other formats and types of files.

The present invention may be implemented on a variety of hardware and software platforms, as described above. More specifically, though, the present invention is directed to methodology in electronic commerce for providing a secure wireless connection service for mobile personal area networks. Before describing the present invention in more detail, though, some background information is provided on wireless personal area networks, and in particular, wireless personal area networks that are implemented in accordance with the Bluetooth™ standard.

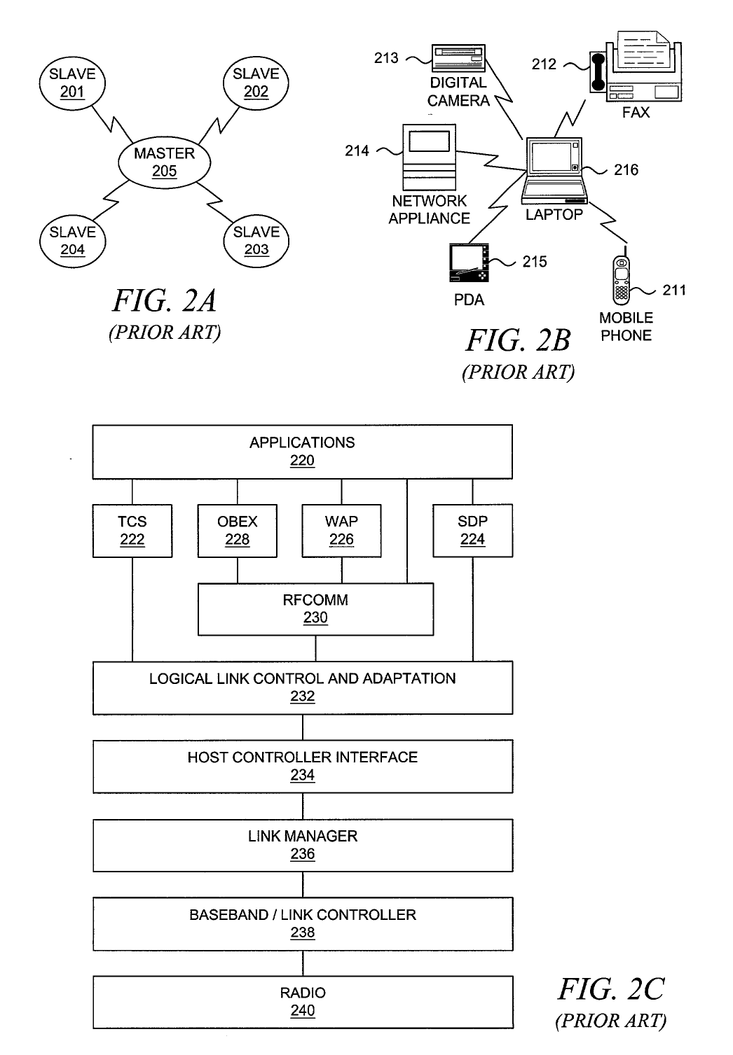

With reference now to FIGS. 2A-2B, two typical representations of a wireless personal area network are depicted. FIGS. 2A-2B depict more detail concerning a personal area network than the generalized network that is shown in FIG. 1A. FIG. 2A abstractly depicts a typical point-to-multipoint piconet with four slave devices 201-204 that are wirelessly communicating with shared master device 205. Slave devices may belong to more than one piconet in a so-called scatternet; multiple master devices may coordinate to create a scatternet. FIG. 2B shows a typical piconet with a set of slave devices: mobile phone 211; fax machine 212; digital camera 213; network appliance 214; and PDA 215. Slave devices 211-215 communicate with laptop computer 216 that acts as the master device for the piconet in accordance with the Bluetooth™ wireless communication standard.

With reference now to FIG. 2C, a block diagram depicts a typical Bluetooth™ protocol stack. Bluetooth™-enabled applications 220 operate in accordance with the Bluetooth™ standard to find other Bluetooth™-enabled devices within the local area and to communicate with those devices as a personal area network. Telephone Control Protocol Specification (TCS) 222 provides telephony services, and Service Discovery Protocol (SDP) 224 allows Bluetooth™-enabled devices to discover the services that are offered by those devices. Wireless Area Protocol (WAP) 226 is a protocol stack similar to the IP stack but tailored for mobile devices, and Object Exchange (OBEX) 228 is a protocol for allowing devices to exchange data simply. RFCOMM 230 provides an RS-232-like serial interface.

Logical link and adaptation layer 232 multiplexes data from higher layers and converts packet sizes as necessary. Host controller interface (HCI) 234 provides an interface such that higher layers of the communication stack can operate on a host device, e.g., a PC, while lower layers can operate on a separable Bluetooth™ module, e.g., a PCMCIA card. Link manager 236 controls and configures links to other devices. Baseband and link controller 238 controls the physical links via the radio, while radio 240 performs the modulation and demodulation that is necessary for transceiving data through radio waves.

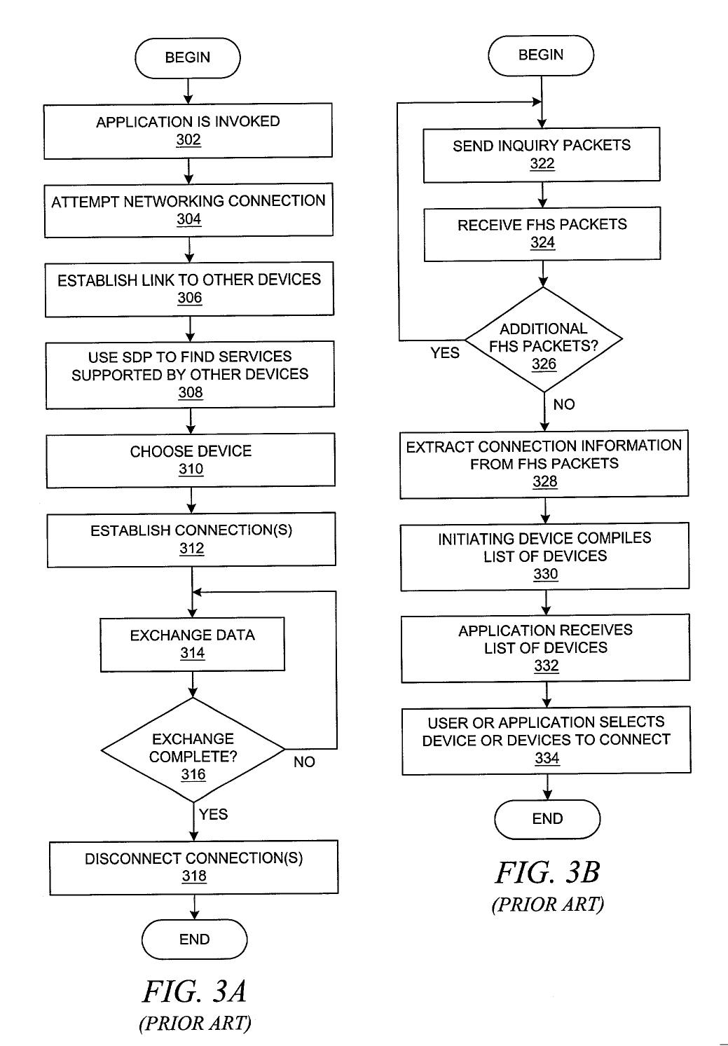

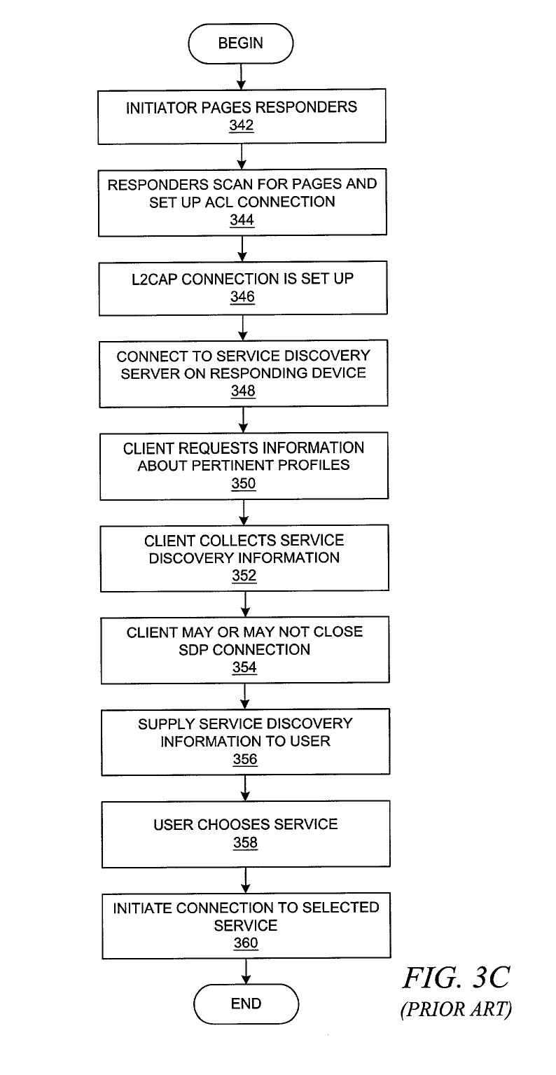

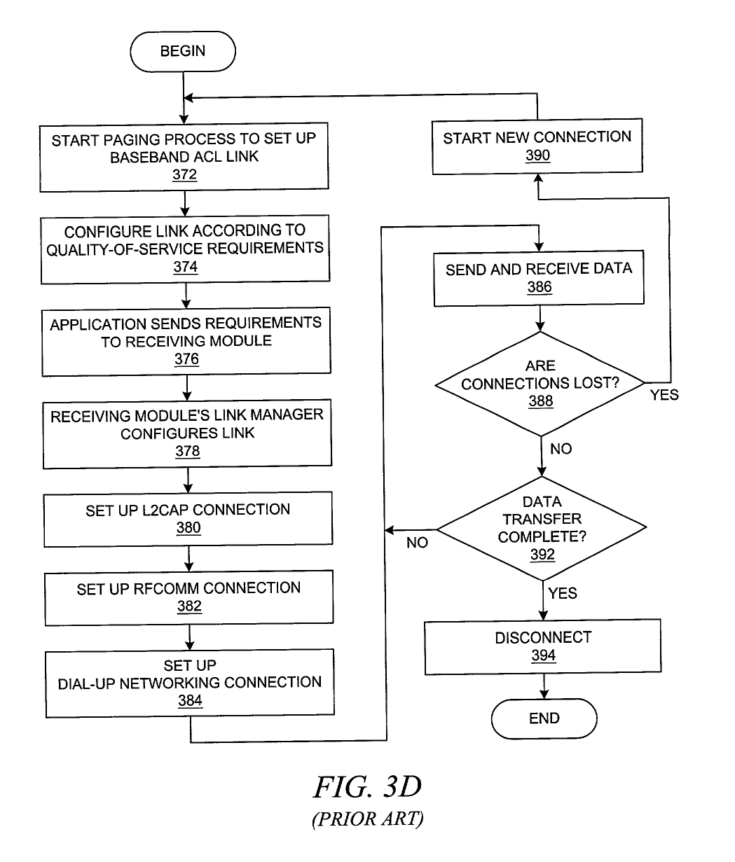

With reference to FIG. 3A, a flowchart depicts a typical discovery and connection process for Bluetooth™-enabled devices. The process begins with an application being invoked on a device in some manner (step 302), and the application attempts to use a particular network service or to open a networking connection, such as a dial-up networking connection (step 304). The device establishes links to other Bluetooth™-enabled devices (step 306) and then uses SDP to discover the services that are supported by the responding devices (step 308). A device that supports the desired service is then chosen (step 310), and a connection is established (step 312). The two devices then exchange data (step 314), and after determining that the data exchange is complete (step 316), the Bluetooth™ connection is terminated (step 318).

With reference to FIG. 3B, a flowchart depicts further details for establishing a link between Bluetooth™-enabled devices. FIG. 3B provides additional detail for step 306 shown in FIG. 3A. The process begins by transmitting inquiry packets (step 322), and the transmitting device receives a frequency hop synchronization (FHS) packet as a response from another Bluetooth™-enabled device (step 324). A determination is made as whether any additional FHS packets are to be received, i.e. whether any addition devices have been discovered (step 326), and if not, then connection information is extracted from the received FHS packets in order to create connections to the other devices (step 328). The initiating device creates a list of Bluetooth™-enabled devices to which it can connect (step 330), and this information is passed to the application (step 332). The application or the user of the application may then select one or more devices to which a connection should be established (step 334).

With reference now to FIG. 3C, a flowchart depicts a typical process for discovering services that are supported by the responding Bluetooth™-enabled devices. FIG. 3C provides additional detail for step 308 shown in FIG. 3A. The process begins when the initiating device pages a responder device using the information that was gathered during the inquiry phase (step 342). Meanwhile, a responding device scans for pages and then responds by setting up an ACL (asynchronous connectionless) connection (step 344). At this point, a logical link control and adaptation protocol (L2CAP) connection can be set up (step 346), which is used to transfer data between devices. The initiating device uses the L2CAP connection to connect to the service discovery server on the responding device (step 348), after which the initiating device (client device) can request information about any pertinent application profiles from the service discovery server (step 350). The client device receives the service discovery information (step 352), after which the client device may or may not close the SDP connection once the service discovery information has been received (step 354). The information about discovered services can then be presented to the user of the initiating/client device (step 356), and the user presumably chooses a service to be used (step 358). The initiating/client device can then start the process of establishing a connection to use the selected service (step 360).

With reference now to FIG. 3D, a flowchart depicts a typical process for establishing a connection to a service that is supported by a Bluetooth™-enabled device. FIG. 3D provides additional detail for step 312 shown in FIG. 3A. The process begins by the initiating device starting another paging process, but this paging process is to set up the baseband ACL link (step 372). If there are quality-of-service requirements that need to be matched for this link, then the link can be configured to meet these requirements (step 374). The application that is requesting to connect to the service can send its requirements to the serving Bluetooth™ module using the host controller interface (step 376), and the module's link manager configures the link using the link management protocol (step 378). After the ACL connection is set up, an L2CAP connection is set up (step 380), and after the L2CAP link has been set up, an RFCOMM connection is set up (step 382). Assuming that the desired service is a dial-up networking connection that can be provided by the serving Bluetooth™ module, then the dial-up networking connection can be set up using the RFCOMM connection (step 384); the RFCOMM module can support several protocols with different channel numbers.

Data can then be sent and received as required (step 386). If it is determined that the serving Bluetooth™-enabled device goes out of range such that the connections are dropped (step 388), then a new connection can be started (step 390) and the process repeated. As long as there is data to be sent (step 392), then the connection can be used. After the data transfer is complete, then the connections can be terminated (step 394).

Given the background information for using wireless personal area networks as supported by the Bluetooth™ standard, it should be noted that the present invention is not intended to be limited to the Bluetooth™ specification and that similar technologies for supporting wireless personal area networks may be used in conjunction with the present invention.

The present invention is directed to a methodology in electronic commerce for supporting a secure wireless PAN network access provider (WPNAP) service so that a user who is operating or carrying a mobile PAN can obtain secure network access, including access to the Internet; after agreeing to purchase the WPNAP service, the purchasers can initiate a secure communication channel, such as a virtual private network (VPN), that is directed to accessing data that is stored within a private network, such as a home network or an office network, including a private PAN. The present invention is described in more detail with respect to the remaining figures.

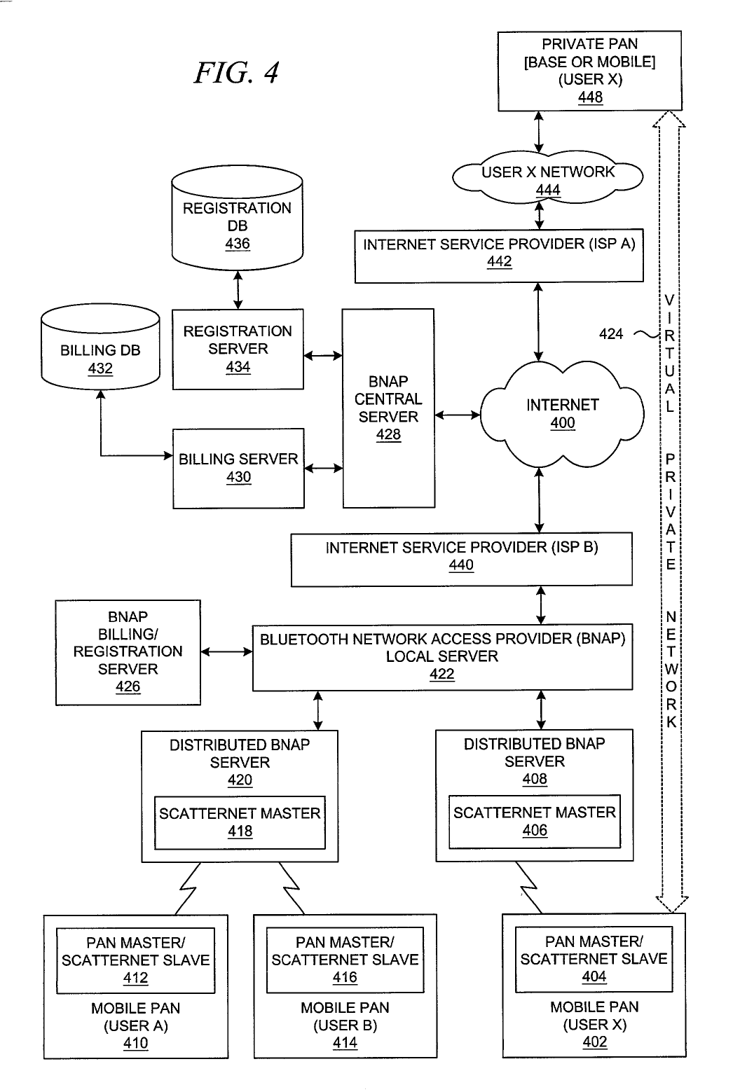

With reference now to FIG. 4, a block diagram depicts some of the functional and physical components that may be interfaced to implement a secure wireless PAN network access provider (WPNAP) service in accordance with the present invention. As noted above, a given implementation of the present invention may be supported by using Bluetooth™ technology as the underlying wireless PAN infrastructure. Hence, the following examples describe a Bluetooth™ network access provider (BNAP) service rather than a WPNAP service. In addition, it should be understood that although FIG. 4 depicts the Internet as network 400 for connecting remote locations, other types of networks could be substituted in place of or combined with the Internet in a manner similar to that described above with respect to FIG. 1A.

FIG. 4 shows mobile PAN 402 that is being used by User X. Mobile PAN 402 comprises at least one Bluetooth™-enabled device 404 that acts as a master device for mobile PAN 402 and that also acts as a slave within a scatternet. This same scatternet comprises Bluetooth™-enabled device 406 that acts as the scatternet master and that is also connected to distributed BNAP server 408. In a similar fashion, User A carries mobile PAN 410 that comprises PAN master/scatternet slave 412, and User B carries mobile PAN 414 that comprises PAN master/scatternet slave 416. Mobile PAN 410 and mobile PAN 414 join another scatternet that is controlled by scatternet master 418 and that is also connected to distributed BNAP server 420. Distributed BNAP servers 408 and 420 connect to local server 422 that controls a set of distributed BNAP servers within a particular location.

In the scenario shown in FIG. 4, a user is carrying a mobile PAN, e.g., a mobile phone, a PDA, and a headset, each of which comprises a Bluetooth™-enabled module/device for interacting together with other Bluetooth™-enabled modules/devices to form a PAN on an ad-hoc basis in which communication can occur directly between two specific nodes. The present invention does not preclude the ability of a device within the PAN having additional functionality that connects the device to a network in which communication can occur between any two nodes that are all connected to a common network based on unique addresses; for example, a device within the PAN may also include a wireless networking module that operates in accordance with the IEEE 802.11 (Wi-Fi or wireless Ethernet) standard.

When User X walks into range of scatternet master 406, User X can be alerted through mobile PAN 402 that User X may register for secure, wireless, network access service that is provided by a particular BNAP. After agreeing to purchase the service offered by the BNAP, mobile PAN 402 can initiate VPN 424. In this example, User X may be carrying mobile PAN 402 while traveling, and the BNAP has installed its service within an airport terminal. Because wireless PAN technologies such as Bluetooth™, have limited operational ranges, multiple BNAP servers, such as servers 408 and 420, would have been placed throughout the airport terminal as required to allow users to connect to the BNAP service throughout the airport terminal.

Distributed BNAP servers 408 and 420 are controlled by local BNAP server 422, which acts as a locally central server for the BNAP service. In one scenario, a BNAP vendor may operate its BNAP service only within this one airport terminal, in which case local BNAP server 422 may interface with billing/registration server 426 for handling financial transactions for the BNAP service.

In a different scenario, the BNAP vendor may offer its service in many different locations, in which case financial transactions may be controlled by BNAP central server 428, which interfaces with billing server 430 to store billing information within billing database 432. BNAP central server 428 may also interface with registration server 434 to store registration information within registration database 436; the operation of a permanent registration database may allow the BNAP vendor to forego certain registration and authentication activities when a user has previously registered for BNAP service and then requests to purchase BNAP service at a later time. The financial infrastructure of the vendor of the BNAP service may be implemented in a variety of equivalent configurations.

It should also be understood that the legal organization of the vendors that offer BNAP service may also vary in a variety of manners that do not affect the present invention. For example, a local BNAP vendor may interact with a separate BNAP vendor that handles the financial transactions for the local BNAP vendor such that the local BNAP vendor can focus on capitalizing and deploying BNAP service in many different locales and regions.

In order to offer the BNAP service in accordance with the present invention, the BNAP service vendor may employ service agreements with other parties, such as ISP 440 and ISP 442, which connect the BNAP service to the Internet and to a BNAP service purchaser's private network 444, respectively. The service agreements between the operator of the BNAP service and the ISPs may depend on a variety of conditions, such as the amount of bandwidth that is consumed by the BNAP service, the time of day at which the network bandwidth is consumed, etc. As a result, the operator of the BNAP service may charge a purchaser of its service based on a variety of conditions, such as the amount of time that the purchaser's mobile PAN is connected to the BNAP service, the amount of data consumed and/or transmitted, the time of day during which the BNAP service is consumed, etc. It should be understood by one of ordinary skill in the art that the conditions for which a BNAP service operator may charge for the BNAP service is not limited to those conditions recited above.

In addition, the BNAP service may be metered in accordance with a variety of conditions that depend on the physical relationship between a purchaser of the service and the environment in which the service is offered. Given that the general nature of a personal area network is to provide ad-hoc connections between devices such that the devices may communicate directly with each other, the BNAP service may be offered in a similar manner in which the connection time occurs during short periods as required or requested by a user.

For example, the operator of the BNAP service may offer timed sessions such that a user carrying a mobile PAN can purchase a block of connection time when the user desires to use the BNAP service at a particular location, and the user's session is terminated after the expiration of the purchased block of connection time. In this manner, the user can remotely connect to a private PAN for relatively short time periods that are sufficient for retrieving and/or storing data within the remote private PAN. Alternatively, the BNAP service may automatically connect and disconnect a previously registered user as required to perform remote access operations to a user's remote, private PAN. In this manner, the user is charged for a plurality of relatively short sessions on an ad-hoc basis which mirrors the ad-hoc nature of the mobile PAN that is interfacing with the BNAP service. It should be understood, however, that other methods for metering BNAP service may be employed by the operator of the BNAP service, and the present invention should not be interpreted as being restricted in the manner in which the BNAP service may be financially accounted.

In summary, when using a configuration of components and functional units similar to that shown in FIG. 4, when User X has wandered into the range of the BNAP service that is offered by the operator of the BNAP service, User X can be registered to use the BNAP service if User X has not been previously registered to use this particular service. After a registration operation or in conjunction with the registration operation, User X agrees to purchase BNAP service in some form.

At this point, User X's mobile PAN can obtain secure access to remote PANs, e.g., by a virtual private network that is dynamically created as necessary when a user wanders into the service area of a BNAP service operator. By using the BNAP service, the user is relieved of the burden of resolving a connectivity-island problem in which datasets that are stored in the user's mobile PAN cannot be archived to the remote PAN and in which the user cannot access datasets that are archived in the remote PAN while moving between locations with the mobile PAN. A secure communication channel that is used to provide the BNAP service may be established in accordance with a variety of well-known standards and/or commercial products.

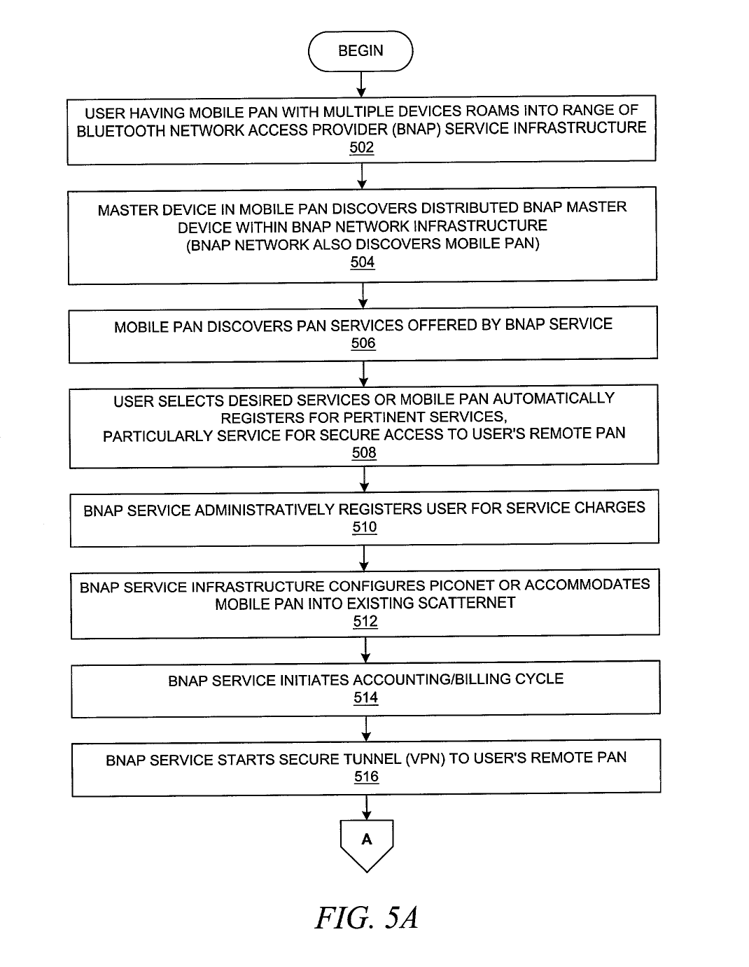

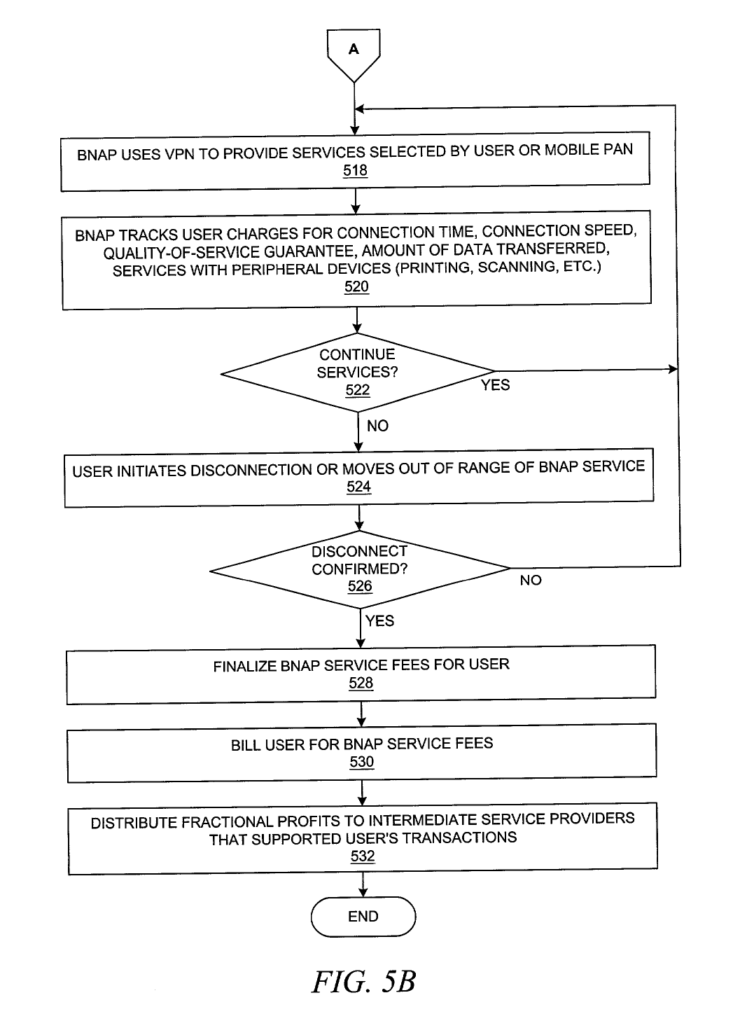

With reference now to FIGS. 5A-5B, a set of flowcharts depict a process by which a Bluetooth™ network access provider (BNAP) service operator can offer a BNAP service and charge for its use in accordance with the present invention. The flowcharts shown in FIG. 5A and FIG. 5B depict greater detail for the operations of a BNAP service infrastructure, similar to that shown in FIG. 4, in accordance with the Bluetooth™ specification for wireless PAN technology.

Referring to FIG. 5A, the process begins when a user that is carrying or operating a mobile PAN enters into a service area of a BNAP service (step 502). The master device in the mobile PAN discovers the distributed BNAP master device within the BNAP network infrastructure (step 504); the BNAP network would also discover the mobile PAN during the same time period. The mobile PAN discovers PAN-enabled services that are offered by the BNAP service (step 506), and the user selects a desired service or services (step 508). Alternatively, the mobile PAN may access the BNAP service and select a needed service as necessary for a particular function that is needed by the mobile PAN. In this particular example, the user selects a service for secure access to a user's remote PAN.

The BNAP service then administratively registers the user for service access and billing (step 510), after which the BNAP service infrastructure configures a Bluetooth™ piconet to include the user's mobile PAN or configures the user's mobile PAN into an existing Bluetooth™ scatternet (step 512). The BNAP service then initiates an accounting/billing cycle and begins charging the user for the BNAP service (step 514). At essentially the same time, the BNAP service starts a secure communication channel or tunnel, e.g., a VPN, to the user's remote PAN (step 516) so that the user can retrieve and/or store data with the remote PAN. In order to connect with the remote PAN, the user may have been required to provide an address or resource identifier of some type for the remote PAN so that the BNAP service can establish the VPN. The address or resource identifier could be provided during the registration process, or the BNAP service may have been able to retrieve a record of the address or resource identifier from a previously created registration record.

The BNAP service uses the newly established VPN to provide the services that have been selected by the user or the mobile PAN (step 518). While the VPN is being used, the BNAP service tracks the charges incurred by the user in accordance with any pertinent metric, such as connection time, connection speed, quality-of-service guarantees, quantity of transferred data, or services with peripheral devices, or any other type of computational metric (step 520). For example, the user may use a local scanner to scan a photograph, which incurs a fee, and the digital copy of the photograph might be stored within the mobile PAN and/or transferred to the user's remote PAN. As another example, the user may use a local printer to print a document that is stored within the mobile PAN, and the printer usage and the cost of the paper incur additional fees. As yet another example, the user may use a local CD-ROM drive to create a CD with certain data or may use some other type of disk drive. In any case, the BNAP service can charge the user for incremental usage fees and for material fees.

While the user's mobile PAN is within the service area, a determination may be periodically made as to whether or not the service should continue (step 522). If so, then the process branches to step 518 to continue the delivery of BNAP service. If not, such as when a user might initiate a disconnection or might move the mobile PAN outside of the service area and the operational range of the BNAP service (step 524), then the BNAP service might confirm the disconnection (step 526), e.g., by prompting the user for a positive indication that the user's session within the BNAP service is being terminated. If the session is not being terminated, then the process branches to step 518 to continue the delivery of BNAP service.

If the session is being terminated, then the BNAP service can finalize the usage fees for the user (step 528), which might require several steps for notifying auxiliary or intermediate service providers, e.g., intermediate ISPs, and collecting the charges from those intermediate service providers. The BNAP service then generates a billing transaction for the user in response to the charges that have been incurred for the recent session (step 530). The BNAP service may also distribute a portion of the charges and/or its profits to intermediate service providers that were used for the user's session (step 532), and the process is complete.

The advantages of the present invention should be apparent in view of the detailed description of the invention that is provided above. The Bluetooth™ specification for supporting wireless PANs furthers the paradigm of ubiquitous computing. However, various barriers to ubiquitous computing remain to be solved, such as the concept of connectivity islands in which a local network or PAN of connected devices are generally inaccessible.

The present invention provides secure, convenient access to remote PANs over Bluetooth™-supported connections. The present invention resolves connectivity issues by providing a methodology in electronic commerce for recouping the intensive capital investment that would be required to install and operate local, convenient, secure, wireless, network access points for mobile PANs.

By allowing a user's mobile PAN to communicate and interact with a user's remote PAN, the intervening distance is essentially eliminated. Hence, with a properly configured infrastructure, the mobile PAN and the remote PAN can interact as if the two PANs were in a local scatternet.

While the present invention is particularly useful for accessing a private PAN that might be located in a home or central office, the present invention allows any two PANs to be physically separate yet functionally interactive. When a user registers with a wireless PAN network access provider service, the user may supply any address or resource identifier for the remote PAN, including another mobile PAN. In this manner, the user's mobile PAN can interact with another user's mobile PAN as a sort of peer-to-peer network. Assuming that the mobile PANs had a common peer-to-peer software application, the two mobile PANs may share data in a peer-to-peer manner.

A subset of the prior art solutions to mobile connectivity problems has included wireless, always-on, Internet connectivity. However, these types of services require permanent user accounts for charging the user for unlimited access to the service provider's infrastructure. In addition, these prior art solutions do not mesh with the sporadic connection requirements of PANs.

The present invention recognizes the ad-hoc nature of PANs in order to provide VPN-secure connectivity as needed or requested on a localized basis. Because of the time and cost involved in deploying wireless network services, particularly in a secure manner, many enterprises cannot afford to provide nationwide wireless services, and many public establishments cannot afford to provide local wireless services. In contrast, a wireless PAN network access provider service that is implemented in accordance with the present invention allows many vendors to profitably set up a local WPNAP service for the benefit of mobile users. Because the WPNAP service can be very localized, the user is not necessarily burdened with waiting for a nationwide or even regional wireless solution to the user's connectivity problems.

It is important to note that while the present invention has been described in the context of a fully functioning data processing system, those of ordinary skill in the art will appreciate that the processes of the present invention are capable of being distributed in the form of instructions in a computer readable medium and a variety of other forms, regardless of the particular type of signal bearing media actually used to carry out the distribution. Examples of computer readable media include media such as EPROM, ROM, tape, paper, floppy disc, hard disk drive, RAM, and CD-ROMs and transmission-type media, such as digital and analog communications links.

The description of the present invention has been presented for purposes of illustration but is not intended to be exhaustive or limited to the disclosed embodiments. Many modifications and variations will be apparent to those of ordinary skill in the art. The embodiments were chosen to explain the principles of the invention and its practical applications and to enable others of ordinary skill in the art to understand the invention in order to implement various embodiments with various modifications as might be suited to other contemplated uses.

What is claimed is:

1. A method for providing a communication service, the method comprising:
activating a stationary personal area network (PAN);
in response to a determination that a wireless mobile PAN has entered a service area of the stationary PAN, offering a network access provider service for the wireless mobile PAN, wherein the network access provider service allows the wireless mobile PAN to connect to a global communication network via the stationary PAN; and
in response to a user input indicative of acceptance of the offered network access provider service, monitoring a session for the wireless mobile PAN on the network access provider service.

2. The method of claim 1 further comprising:
generating a financial transaction to charge fees to a user of the wireless mobile PAN for use of the network access provider service during the monitored session.

3. The method of claim 1 further comprising:
creating a secure communication channel between the wireless mobile PAN and a remote PAN via the global communication network.

4. The method of claim 3 further comprising:
receiving from a user of the wireless mobile PAN an indication of an address or resource identifier for the remote PAN.

5. The method of claim 4 wherein the remote PAN is a wireless mobile PAN.

6. The method of claim 4 further comprising:
sharing data between the wireless mobile PAN and the remote PAN through a peer-to-peer application.

7. The method of claim 1 further comprising:
detecting the wireless mobile PAN by the stationary PAN, wherein the stationary PAN comprises a master device; and
establishing a wireless communication link between the wireless mobile PAN and the master device of the stationary PAN such that the wireless mobile PAN joins a piconet or scatternet supported by the master device of the stationary PAN.

8. The method of claim 1 further comprising:
presenting for discovery by the wireless mobile PAN a set of one or more services supported by the stationary PAN, wherein the network access provider service is one of the services supported by the stationary PAN; and
starting a session with the network access provider service.

9. The method of claim 8 further comprising:
registering a user of the wireless mobile PAN as a user of the network access provider service.

10. The method of claim 9 further comprising:
receiving financial identification information from the user of the wireless mobile PAN for payment for use of the stationary PAN.

11. The method of claim 8 further comprising:
presenting use of a peripheral device connected to the stationary PAN as a service in the set of one or more services supported by the stationary PAN; and
charging a usage fee to the user of the wireless mobile PAN in response to use of the peripheral device.

12. The method of claim 1 further comprising:
generating a financial transaction to share fees received from use of the network access provider service with an operator of a service that supports the network access provider service.

13. A computer program product in a computer readable medium for use in a data processing system for providing a communication service, the computer program product comprising:
instructions for activating a stationary personal area network (PAN);
instructions for offering a network access provider service for a wireless mobile PAN in response to a determination that the wireless mobile PAN has entered a service area of the stationary PAN, wherein the network access provider service allows the wireless mobile PAN to connect to a global communication network via the stationary PAN; and
instructions for monitoring a session for the wireless mobile PAN on the network access provider service in response to a user input indicative of acceptance of the offered network access provider service.

14. The computer program product of claim 13 further comprising:
instructions for generating a financial transaction to charge fees to a user of the wireless mobile PAN for use of the network access provider service during the monitored session.

15. The computer program product of claim 13 further comprising:
instructions for creating a secure communication channel between the wireless mobile PAN and a remote PAN via the global communication network.

16. The computer program product of claim 15 further comprising:
instructions for receiving from a user of the wireless mobile PAN an indication of an address or resource identifier for the remote PAN.

17. The computer program product of claim 16 wherein the remote PAN is a wireless mobile PAN.

18. The computer program product of claim 16 further comprising:
instructions for sharing data between the wireless mobile PAN and the remote PAN through a peer-to-peer application.

19. The computer program product of claim 13 further comprising:
instructions for detecting the wireless mobile PAN by the stationary PAN, wherein the stationary PAN comprises a master device; and
instructions for establishing a wireless communication link between the wireless mobile PAN and the master device of the stationary PAN such that the wireless mobile PAN joins a piconet or scatternet supported by the master device of the stationary PAN.

20. The computer program product of claim 13 further comprising:
instructions for presenting for discovery by the wireless mobile PAN a set of one or more services supported by the stationary PAN, wherein the network access provider service is one of the services supported by the stationary PAN; and
instructions for starting a session with the network access provider service.

21. The computer program product of claim 20 further comprising:
instructions for registering a user of the wireless mobile PAN as a user of the network access provider service.

22. The computer program product of claim 21 further comprising:
instructions for receiving financial identification information from the user of the wireless mobile PAN for payment for use of the stationary PAN.

23. The computer program product of claim 20 further comprising:
instructions for presenting use of a peripheral device connected to the stationary PAN as a service in the set of one or more services supported by the stationary PAN; and
instructions for charging a usage fee to the user of the wireless mobile PAN in response to use of the peripheral device.

24. The computer program product of claim 13 further comprising:
instructions for generating a financial transaction to share fees received from use of the network access provider service with an operator of a service that supports the network access provider service.

25. An apparatus for providing a communication service, the apparatus comprising:
means for activating a stationary personal area network (PAN);
means for offering a network access provider service for a wireless mobile PAN in response to a determination that the wireless mobile PAN has entered a service area of the stationary PAN, wherein the network access provider service allows the wireless mobile PAN to connect to a global communication network via the stationary PAN; and
means for monitoring a session for the wireless mobile PAN on the network access provider service in response to a user input indicative of acceptance of the offered network access provider service.

26. The apparatus of claim 25 further comprising:
means for generating a financial transaction to charge fees to a user of the wireless mobile PAN for use of the network access provider service during the monitored session.

27. The apparatus of claim 25 further comprising:
means for creating a secure communication channel between the wireless mobile PAN and a remote PAN via the global communication network.

28. The apparatus of claim 25 further comprising:
means for presenting for discovery by the wireless mobile PAN a set of one or more services supported by the stationary PAN, wherein the network access provider service is one of the services supported by the stationary PAN; and
means for starting a session with the network access provider service.
